(19) United States
(12) Patent Application Publication
(10) Pub. No.: US 2025/0173839 A1
(43) Pub. Date: May 29, 2025

(54) VIDEO EDITING METHODS AND APPARATUSES

(71) Applicant: Alipay (Hangzhou) Information Technology Co., Ltd., Hangzhou (CN)

(72) Inventors: Xingning Dong, Hangzhou (CN); Yutao Chen, Hangzhou (CN); Qing WANG, Hangzhou (CN); Qingpei Guo, Hangzhou (CN)

(73) Assignee: Alipay (Hangzhou) Information Technology Co., Ltd., Hangzhou (CN)

(21) Appl. No.: 18/949,360

(22) Filed: Nov. 15, 2024

(30) Foreign Application Priority Data
Nov. 27, 2023 (CN) 202311594465.X

(51) Int. Cl. G06T 5/70; G06T 5/50; G06T 7/13; G06T 7/20; G06T 7/50; H04N 19/172

(52) U.S. Cl. CPC G06T 5/70; G06T 5/50; G06T 7/13; G06T 7/20; G06T 7/50; H04N 19/172; G06T 2207/20182; G06T 2207/20221

(57) ABSTRACT

A computer-implemented method includes determination of n noised codes corresponding to n video frames of an original video. A text code corresponding to a description text guiding video editing is determined. Denoising processing, using n Unet models obtained by using the text code and copying a Unet model, is performed on the n noised codes, where a pre-trained text-to-image model includes the Unet model, which includes a self-attention layer connected after a target network layer, and where the denoising processing includes performing, in a self-attention layer of any ith Unet model, attention calculation based on an output of a target network layer of the ith Unet model and an output of a target network layer in a predetermined target Unet model. Decoding processing is separately performed on the n denoised codes by an image decoder to obtain n target images to form an edited target video.

### CROSS-REFERENCE TO RELATED APPLICATIONS

This application claims priority to Chinese Patent Application No. 202311594465.X, filed on Nov. 27, 2023, which is hereby incorporated by reference in its entirety.

### TECHNICAL FIELD

One or more embodiments of this specification associated with the field of machine learning technologies, and in particular, to video editing methods and apparatuses, computer-readable storage mediums, and computing devices.

### BACKGROUND

Currently, a machine learning technology is widely used in many different fields, such as user recommendation and video editing. In the field of video editing, it is expected that, in a text-driven manner, automatic editing of a given video is implemented by using a constructed machine learning model. Editing content includes video elements such as a subject, a style, and a background. For example, as shown in FIG. 1, a person in a ski suit in a given video is driven by a text “a man in an armor is skiing”, and is replaced with a man in an armor.

However, currently, a manner of implementing video editing by using the machine learning technology cannot satisfy a higher requirement in an actual application. Therefore, embodiments of this specification disclose a video editing solution, which can satisfy a higher requirement in an actual application, such as reducing a calculation cost and improving an editing effect.

### SUMMARY

Embodiments of this specification describe video editing methods and apparatuses, which can effectively reduce a calculation cost, improve an editing effect, etc.

According to a first aspect, a video editing method is provided, implemented based on a pre-trained text-to-image model, where the text-to-image model includes a Unet model, and the method includes: determining n noised codes corresponding to n video frames of an original video, and determining a text code corresponding to a description text guiding video editing; performing denoising processing on the n noised codes by using the text code and n Unet models obtained by copying the Unet model, to obtain n denoised codes, where each Unet model includes a self-attention layer connected after a target network layer, and the denoising processing includes: performing, in a self-attention layer of any ith Unet model, attention calculation based on an output of a target network layer of the ith Unet model and an output of a target network layer in a predetermined target Unet model; and separately performing decoding processing on the n denoised codes to obtain n target images, so as to form an edited target video.

In an embodiment, the pre-trained training data include a text-image pair.

In an embodiment, before the determining n noised codes corresponding to n video frames of an original video, and determining a text code corresponding to a description text guiding video editing, the method further includes: obtaining the original video and the description text that are inputted by a user.

In an embodiment, the performing, in a self-attention layer of any ith Unet model, attention calculation based on an output of a target network layer of the ith Unet model and an output of a target network layer in a predetermined target Unet model includes: processing, by using a query parameter matrix in the self-attention layer of the any ith Unet model, the output of the target network layer of the ith Unet model, to obtain a query matrix Q; processing the output of the target network layer in the target Unet model by separately using a key parameter matrix and a value parameter matrix, to obtain a key matrix K and a value matrix V; and determining an output of a current self-attention layer based on the query matrix Q, the key matrix K, and the value matrix V.

In an embodiment, the text-to-image model further includes an image information encoder for image information of a predetermined category, and a self-attention layer of the any Unet model is located in a downsampling module; and before the performing denoising processing on the n noised codes by using the text code and n Unet models obtained by copying the Unet model, to obtain n denoised codes, the method further includes: extracting n pieces of image information in the image information of the predetermined category from the n video frames; and separately processing the n pieces of image information by using the image information encoder, to obtain n information codes. The denoising processing further includes: in any ith Unet model, fusing an output of a downsampling module of the ith Unet model with an ith information code, and inputting to a next module.

In a specific embodiment, the separately processing the n pieces of image information by using the image information encoder, to obtain n information codes includes: processing the n pieces of image information in parallel by using n image information encoders obtained by copying the image information encoder, to obtain the n image information codes.

In another specific embodiment, the predetermined image information category includes depth information, edge information, or an optical flow graph of an image.

In still another specific embodiment, the predetermined image information category includes depth information, the image information encoder is a depth information encoder, the n pieces of image information are n pieces of depth information, and the n information codes are n depth codes; and before the performing denoising processing, the method further includes: separately performing a negation operation on the n pieces of depth information to obtain n pieces of reverse depth information; separately processing the n pieces of reverse depth information by using the depth information encoder, to obtain n reverse depth codes; and updating each depth code of the n depth codes to a fusion result between the depth code and a corresponding reverse depth code.

Further, in an example, the updating each depth code of the n depth codes to a fusion result between the depth code and a corresponding reverse depth code includes: performing weighted summation on each depth code and the corresponding reverse depth code by using a predetermined weight, to obtain a corresponding fusion result.

In an embodiment, the text-to-image model further includes an image encoder; and the determining n noised codes corresponding to n video frames of an original video includes: separately performing coding processing on the n video frames by using the image encoder, to obtain n original codes; and performing noise addition processing on the n original codes to obtain the n noised codes.

In a specific embodiment, the separately performing coding processing on the n video frames by using the image encoder, to obtain n original codes includes: generating, for each video frame in the n video frames, a binary image used to shade an area requiring no editing; and processing, by using the image encoder, a complete pixel image of the video frame and a shaded pixel image obtained by performing element-wise multiplication on the binary image, to obtain a corresponding original code. After the separately processing the n denoised codes by using the image decoder to obtain n target images, the method further includes: for each target image in the n target images, fusing the target image with an image of an area requiring no editing in a corresponding video frame, to obtain a corresponding target video frame; and constructing the target video by using n target video frames corresponding to the n target images.

According to another aspect, in a specific embodiment, the n Unet models are n first Unet models; and the performing noise addition processing on the n original codes to obtain the n noised codes includes: performing noise addition processing on the n original codes by using a text code set to zero and n second Unet models obtained by copying the Unet model, to obtain the n noised codes.

In an embodiment, the text-to-image model further includes an image decoder; and the separately performing decoding processing on the n denoised codes to obtain n target images includes: separately processing the n denoised codes by using the image decoder, to obtain the n target images.

In an embodiment, the Unet model includes multiple downsampling modules, several intermediate modules, and multiple upsampling modules, where each of the modules includes the self-attention layer.

In a specific embodiment, each of the modules further includes a convolutional layer, an activation layer, a pooling layer, a cross-attention layer, and a fully connected layer, and an input to the cross-attention layer includes a text code.

According to a second aspect, a video editing apparatus is provided, where a function of the apparatus is implemented based on a pre-trained text-to-image model, where the text-to-image model includes a Unet model, and the apparatus includes: a noise addition and code image module, configured to determine n noised codes corresponding to n video frames of an original video; a code text module, configured to determine a text code corresponding to a description text guiding video editing; a denoising module, configured to perform denoising processing on the n noised codes by using the text code and n Unet models obtained by copying the Unet model, to obtain n denoised codes, where each Unet model includes a self-attention layer connected after a target network layer, and the denoising processing includes: performing, in a self-attention layer of any ith Unet model, attention calculation based on an output of a target network layer of the ith Unet model and an output of a target network layer in a predetermined target Unet model; and a decoding module, configured to separately perform decoding processing on the n denoised codes to obtain n target images, so as to form an edited target video.

According to a third aspect, a video editing method is provided, implemented based on a pre-trained text-to-image model, where the text-to-image model includes a Unet model, and the method includes: determining n noised codes corresponding to n video frames of an original video, and determining a text code corresponding to a description text guiding video editing; separately performing denoising processing on the n noised codes by using the text code and the Unet model, to obtain n denoised codes, where the Unet model includes a self-attention layer connected after a target network layer, and performing denoising processing on any ith noised code includes: performing, in the self-attention layer of the Unet model, attention calculation based on a first output of the target network layer for the ith noised code and a second output of the target network layer for a predetermined target noised code; and separately performing decoding processing on the n denoised codes to obtain n target images, so as to form an edited target video.

In an embodiment, the performing, in the self-attention layer of the Unet model, attention calculation based on an output of the target network layer for the ith noised code and an output of the target network layer for a predetermined target noised code includes: processing the first output in the self-attention layer by using a query parameter matrix, to obtain a query matrix Q; separately processing the second output by using a key parameter matrix and a value parameter matrix, to obtain a key matrix K and a value matrix V; and determining an output of a current self-attention layer based on the query matrix Q, the key matrix K, and the value matrix V.

In an embodiment, the text-to-image model further includes an image information encoder for image information of a predetermined category, and a self-attention layer of the Unet model is located in a downsampling module; and before the separately performing denoising processing on the n noised codes by using the text code and the Unet model, the method further includes: extracting n pieces of image information in the image information of the predetermined category from the n video frames; and separately processing the n pieces of image information by using the image information encoder, to obtain n information codes. The denoising processing further includes: in the Unet model, fusing an output of a downsampling module of the Unet model for an ith noised code with an ith information code, and inputting to a next module.

In an embodiment, the text-to-image model further includes an image encoder; and the determining n noised codes corresponding to n video frames of an original video includes: separately performing coding processing on the n video frames by using the image encoder, to obtain n original codes; and performing noise addition processing on the n original codes to obtain the n noised codes.

Further, in a specific embodiment, the performing noise addition processing on the n original codes to obtain the n noised codes includes: separately performing noise addition processing on the n original codes by using a text code set to zero and the Unet model, to obtain the n noised codes.

According to a fourth aspect, a video editing apparatus is provided, where a function of the apparatus is implemented based on a pre-trained text-to-image model, where the text-to-image model includes a Unet model, and the apparatus includes: a noise addition and code image module, configured to determine n noised codes corresponding to n video frames of an original video, and determine a text code corresponding to a description text guiding video editing; a code text module, configured to separately perform denoising processing on the n noised codes by using the text code and the Unet model, to obtain n denoised codes, where the Unet model includes a self-attention layer connected after a target network layer, and performing denoising processing on any ith noised code includes: performing, in the self-attention layer, attention calculation based on a first output of the target network layer for the ith noised code and a second output of the target network layer for a predetermined target noised code; and a denoising module, configured to separately perform decoding processing on the n denoised codes to obtain n target images, so as to form an edited target video.

According to a fifth aspect, a computer-readable storage medium is provided, where a computer program is stored in the computer-readable storage medium, and when the computer program is executed on a computer, the computer is enabled to perform the method according to the first aspect or the third aspect.

According to a sixth aspect, a computing device is provided, including a memory and a processor, where executable code is stored in the memory, and when the processor executes the executable code, the method according to the first aspect or the third aspect is implemented.

In the above-mentioned method and apparatus provided in the embodiments of this specification, no additional training or fine adjustment needs to be performed on the pre-trained text-to-image model, but the text-to-image model can be directly used to process the original video and the description text guiding video editing, so as to generate an edited video with a good visual effect and better consistency.

### BRIEF DESCRIPTION OF DRAWINGS

To describe the technical solutions in the embodiments of this application more clearly, the following briefly describes the accompanying drawings needed for describing the embodiments. Clearly, the accompanying drawings in the following descriptions show merely some embodiments of this application, and a person of ordinary skill in the art can still derive other accompanying drawings from these accompanying drawings without creative efforts.

FIG. 1 is a schematic diagram of a scenario in which text-driven video editing is implemented by using a machine learning model;

FIG. 2 is a schematic diagram of an implementation architecture of a video editing solution disclosed in an embodiment of this specification;

FIG. 3 is a first schematic flowchart of a process step of a video editing method disclosed in an embodiment of this specification;

FIG. 4 is a schematic structural diagram of a module connection of a Unet model;

FIG. 5 is a schematic structural diagram of a network layer connection of each module in FIG. 4;

FIG. 6 is a second schematic flowchart of a process step of a video editing method disclosed in an embodiment of this specification;

FIG. 7 is a first schematic structural diagram of a video editing apparatus disclosed in an embodiment of this specification; and

FIG. 8 is a second schematic structural diagram of a video editing apparatus disclosed in an embodiment of this specification.

### DESCRIPTION OF EMBODIMENTS

The following describes the solutions provided in this specification with reference to the accompanying drawings.

As previously described, in the field of video editing, it is expected that, in a text-driven manner, automatic editing of a given segment of video is implemented by using a constructed machine learning model. Currently, in the industry, using a text to control image generation and image editing has made great progress. In particular, a text-to-image model is mature, so an edited single image has an excellent visual effect.

In consideration that a video is actually an image sequence including multiple images, implementing text-controlled video generation based on a pre-trained text-to-image model is proposed. It should be understood that pre-training refers to pre-training a model by using mass data, where the mass data generally cover as many fields as possible, so a pre-trained text-to-image model has strong universality. In addition, most of mainstream text-to-image models are open-sourced and support downloading corresponding pre-training models as required.

In one manner, frame-by-frame editing of a video can be performed by using a text-to-image model. However, this manner does not take into account a continuous problem of a video frame, and a coherence effect is not good. In another manner, the text-to-image model is expanded based on a video editing task, and a new time sequence module is added to fine-tune weights of some modules based on a pre-training weight (or referred to as a pre-training model parameter) of the text-to-image model. However, as such, a training sample and a large quantity of hardware resources need to be consumed.

Based on the above-mentioned observation and analysis, the embodiments of this specification propose a video editing solution, which does not need to perform any additional training, but can directly use a pre-trained text-to-image model to generate an edited video with a better visual effect and better coherence under text guidance.

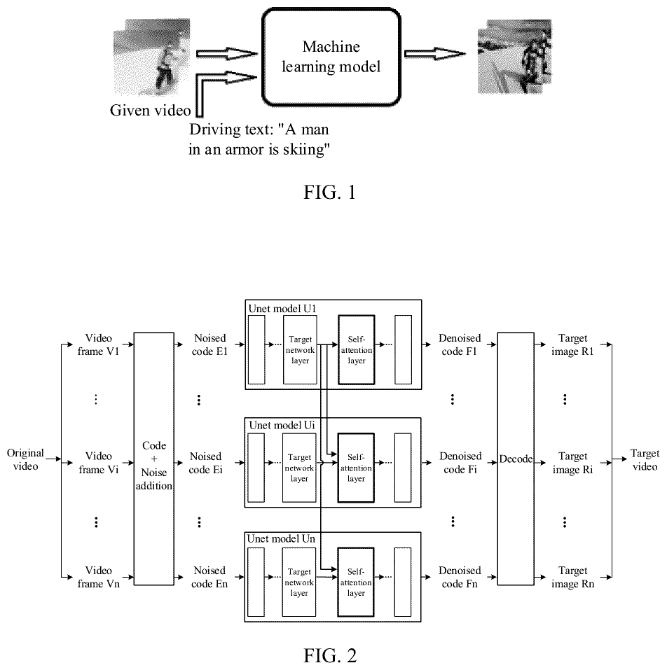

FIG. 2 is a schematic diagram of an implementation architecture of a video editing solution disclosed in an embodiment of this specification, where n (≥2) Unet models obtained by copying a Unet model included in a pre-trained text-to-image model are shown, and any ith Unet model is used to perform, under text guidance (text guidance is not shown in FIG. 1), denoising processing on a noised code Ei corresponding to an ith video frame Vi of an original video to obtain a corresponding denoised code Fi, so as to obtain, through decoding, a target image Ri used to form an edited target video. In the video editing solution, a manner of using a self-attention layer in the Unet model is modified. Specifically, in addition to an output of a neighboring target network layer, an input to a self-attention layer in the ith Unet model further includes an output of a target network layer in a predetermined target Unet model (the target Unet model shown in FIG. 2 is the first Unet model U1). Therefore, cross-frame attention can be implemented, so n subsequently generated target images are coherent. It is worthwhile to note that, to reflect that a model parameter of the self-attention layer is not modified in the video editing solution, a name of the self-attention layer in the Unet model is still used. Actually, in the video editing solution, the name can alternatively be renamed as a cross-frame attention layer.

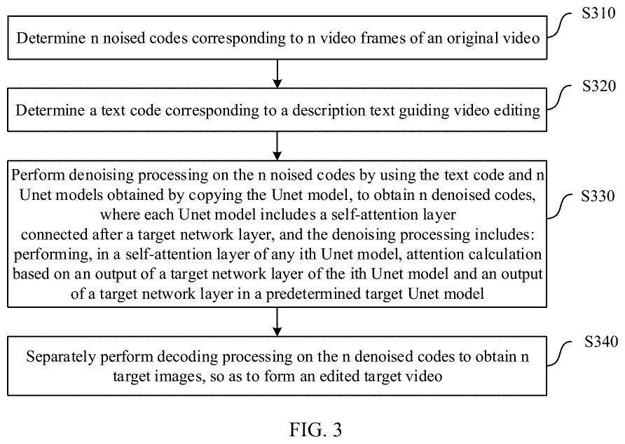

The following describes specific implementation steps of the above-mentioned video editing solution with reference to FIG. 3 and more embodiments.

FIG. 3 is a first schematic flowchart of a process step of a video editing method disclosed in an embodiment of this specification. The video editing method is implemented based on a pre-trained text-to-image model. For example, the text-to-image model can be a current mainstream stable diffusion model, and includes an image decoder and a Unet model. It should be understood that pre-trained training data include multiple text-image pairs, and do not include labeled data at a video granularity. Because the video editing method disclosed in the embodiments of this specification uses an existing pre-trained model, and does not involve improvement of a pre-training manner, a pre-training process is not described excessively and can be mentioned as required in the following description. In addition, the video editing method can be performed by any apparatus, server, platform, or device cluster having computing and processing capabilities, for example, can be video editing software.

As shown in FIG. 3, the method includes the following steps:

Step S310: Determine n noised codes corresponding to n video frames of an original video.

It can be understood that the original video is a video to be edited, or a video before editing. For example, the original video can be a video uploaded by a user based on a video editing interface. In addition, the n video frames (or referred to as n original video frames) are obtained by performing frame extraction on the original video, and a value of n depends on a rule preconfigured by a worker. For example, multiple video frames can be extracted from the original video at a predetermined time interval (such as 100 ms) as the n video frames.

In an implementation A, this step can be implemented still in a manner of obtaining a noised code of an image to be edited in a pre-training phase. Specifically, coding processing is performed on the n video frames one by one by using an image encoder (for example, a variational autoencoder), to obtain the n original codes, and then noise addition processing is separately performed on the n original codes, to obtain the n noised codes. For example, the noise addition processing corresponds to a forward diffusion process in a stable generation model.

In an implementation B, coding processing in the implementation A can be improved. Specifically, compared with performing serial processing on the n video frames by using one image encoder in the implementation A, it is proposed that n image encoders obtained by copying the image encoder process the n video frames in parallel to obtain the n original codes. For example, the image encoder is copied by n−1 times to obtain n−1 image encoders, which form n image encoders together with the copied image encoder.

In addition, in this embodiment of this specification, another improvement on a coding processing manner and improvement on noise addition processing are further proposed. Because related content relates to descriptions of other steps, for clarity and brevity, further description is provided in the following.

As such, by performing step S310, the n noised codes corresponding to the n original video frames can be obtained.

Before, after, or at the same time as step S310 is performed, step S320 can be performed to determine a text code corresponding to a description text guiding video editing.

It can be understood that the description text is used to guide and drive video editing, and can be customized by a user. For example, the description text shown in FIG. 1 is “a man in an armor is skiing”, and actually can be “a dog in a down coat is skiing”.

This step can be implemented still in a manner of coding a text in the pre-training phase. Specifically, the text-to-image model further includes a text encoder. For example, an encoder for coding a text in a contrastive language-image pre-training (CLIP) used to match an image against a text can be directly used as the text encoder in the text-to-image model. Therefore, the description text can be inputted into the text encoder to obtain a corresponding text code.

As such, the text code corresponding to the description text can be obtained.

Based on the above-mentioned obtained text code of the description text and the n noised codes corresponding to the n video frames, step S330 is performed to perform denoising processing on the n noised codes by using the text code and n Unet models obtained by copying the Unet model, to obtain n denoised codes.

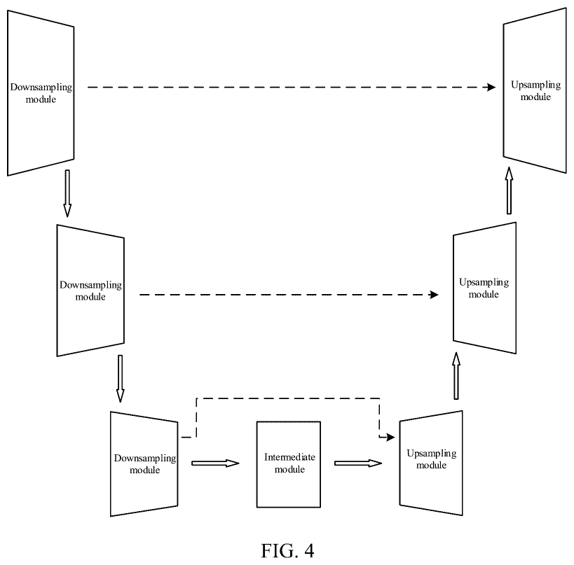

For ease of understanding, the following first briefly describes the Unet model in the text-to-image model. As shown in FIG. 4, the model structure is similar to the letter “U”, and is thus referred to as U-Net. The Unet model mainly includes three types of modules, a downsampling module, an intermediate module, and an upsampling module. A quantity of modules of each type can be one or more (or referred to as several). FIG. 4 schematically shows three downsampling modules, one intermediate module, and three upsampling modules. After a noised code (essentially a feature map) is inputted into the Unet model, under guidance of the text code, a size processed by multiple downsampling modules becomes smaller and smaller, the size processed by the intermediate module is unchanged, and the size processed by multiple upsampling modules becomes larger and larger. Generally, the size is restored to the size of the noised code. It should be understood that an input to an upsampling module can further include an output of a downsampling module in a symmetrical position (for this, references can be made to a dashed line arrow in FIG. 4).

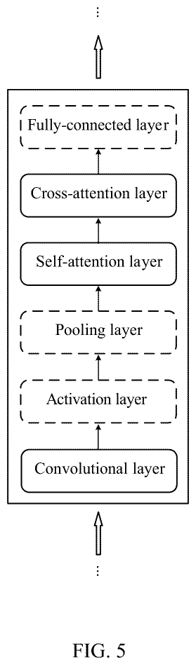

As shown in FIG. 5, each module of the Unet model includes a convolutional layer, a self-attention layer, and a cross-attention layer, and can selectively include an activation layer, a pooling layer, and a fully connected layer. An arrangement order and a quantity of different layers in each module are configured by a worker based on experience. FIG. 5 shows a typical arrangement order of different network layers in each module. It can be understood that an input to an initial convolutional layer in the first downsampling module is a noised code, and an input to a cross-attention layer in each module further includes a text code in addition to an output of an upper layer. In addition, there is a difference between the same type of network layers in different modules, for example, there is a difference in a size, a quantity, or a weight parameter of a convolution kernel in a convolutional layer.

The previous describes the Unet model in text-to-image. In this step, the n Unet models obtained by copying the Unet model are used, so a manner of using a self-attention layer in each Unet model is modified to cross-frame attention, and the n noised codes and the text code are processed to obtain the n denoised codes that undergo cross-frame interaction.

Specifically, an above-mentioned network layer of a self-attention layer in any ith Unet model (or each Unet model) is referred to as a target network layer. For example, the target network layer can be a pooling layer (refer to FIG. 4 for this), an activation layer, or a convolutional layer. Based on this, the denoising processing in this step includes: performing, in a self-attention layer of an ith Unet model, attention calculation based on an output of a target network layer of the ith Unet model and an output of a target network layer in a predetermined target Unet model.

The target Unet model can be flexibly specified. In an embodiment, a target model corresponding to each Unet model is the same, for example, is a predetermined jth Unet model, for example, j=1 (refer to FIG. 1 for this). In another embodiment, a target model corresponding to the ith Unet model is an (i−1)th model, and a target Unet model of the first Unet model is itself or another Unet model, such as the second Unet model.

For the above-mentioned attention calculation, in a possible case, implementation of the self-attention layer of the Unet model is based on a self-attention mechanism in Transformer, and in this case, the self-attention layer involves calculation of a query matrix Q, a key matrix K, and a value matrix V. In this case, in an embodiment, the self-attention calculation can include: processing, by using a query parameter matrix W_{q} in the self-attention layer of the any ith Unet model, the output Zᵢ of the target network layer of the ith Unet model, to obtain a query matrix Q; and processing the output Zⱼ (for example, Zⱼ=Z₁) of the target network layer in the target Unet model by separately using a key parameter matrix Wₖ and a value parameter matrix Wᵥ, to obtain a key matrix K and a value matrix V. In this embodiment, processing performed by using each parameter matrix is linear transformation processing. For example, references can be made to the following equation (1):

$$Q = {W}_{q} * {Z}_{i}^{T} \qquad ( 1 )$$

$$K = {W}_{k} * {Z}_{j}^{T}$$

$$V = {W}_{v} * {Z}_{j}^{T}$$

The superscript T represents a transpose operation of the matrix.

In another embodiment, the self-attention calculation can be implemented by using the following equation (2):

$$Q = {W}_{q} * {Z}_{j}^{T} \qquad ( 2 )$$

$$K = {W}_{k} * {Z}_{i}^{T}$$

$$V = {W}_{v} * {Z}_{i}^{T}$$

Further, in the self-attention layer of the ith Unet model, an output of a current self-attention layer can be determined based on the query matrix Q, the key matrix K, and the value matrix V. For details, an original calculation manner in the Unet model can still be used. Details are omitted here for simplicity.

In another possible case, the attention calculation in this step can be implemented by using the following equation (3):

$$A = softmax ( {Z}_{i} * {Z}_{j}^{T} ) \qquad ( 3 )$$

In Equation (3), A represents an attention matrix, and softmax is a normalization function that acts on a product result matrix of Zᵢ*Zⱼ^{T} by row.

Further, the output O of the current attention layer can be determined based on A and Zᵢ, for example, the following equation (4) is used:

$$O = A * {Z}_{i} \qquad ( 4 )$$

In the above-mentioned description, the manner of using the self-attention layers in the n Unet models is improved, so as to implement cross-frame interaction between the n video frames, thereby achieving good coherence between the n denoised codes outputted by the n Unet models.

In addition, in a possible case, the text-to-image model further includes a depth information encoder, and an output of the depth information encoder is introduced in denoising processing, so continuity of an edited video can be constrained by using explicit depth information. For example, the depth information encoder can include multiple residual blocks. The following first describes related implementation steps before improvement to the implementation steps.

Specifically, for the n video frames in the original video, depth information of each video frame in the n video frames is first extracted, and then n pieces of depth information of the n video frames are separately processed by using the depth information encoder to obtain n depth codes. Based on this, the denoising processing further includes: in any ith Unet model, fusing an output of a downsampling module of the ith Unet model with an ith information code, and inputting to a next module.

It should be understood that the depth information is also referred to as a depth map, and indicates distance information from each point in a photographed scene in an image to a photographing device. In an embodiment, the original video is photographed by using a binocular camera. In this case, depth information is included in a parameter of a photographed image, so the depth information can be directly extracted from a photographing parameter. In another embodiment, the original video is photographed by using a monocular camera. In this case, an existing monocular depth estimation algorithm such as a structure from motion or a depth information extraction model based on a machine learning technology can be used to extract depth information.

In addition, for any ith Unet model, if the ith Unet model includes multiple downsampling modules, an output of each downsampling module in all or some of the downsampling modules can be fused with an ith information code, and then inputted into a next module. It can be learned from FIG. 4 that a next module of a downsampling module may be another downsampling module or an intermediate module.

The following describes further improvement proposed to the above-mentioned implementation steps.

In an improvement manner, it is proposed to constrain a generated video frame to maintain consistency of details of far and near fields by performing a negation operation on depth information. The details include:

1) First, a negation operation is separately performed on n pieces of depth information to obtain n pieces of reverse depth information in which the foreground and the background are reversed. It should be understood that the negation operation can be implemented by using an existing technology, and details are not described.

2) Then, the depth information encoder is used to separately process the n pieces of reverse depth information to correspondingly obtain n reverse depth codes, and the n depth codes and the n reverse depth codes are fused in pairs. The details include the following: First fusion processing is performed on a depth code and a reverse depth code that are corresponding to the same video frame to obtain a total of n fusion codes.

In a specific embodiment, the first fusion processing manner can be weighted summation, and a weight used for weighted summation can be predetermined. For example, the following equation (5) can be used to calculate any ith fusion code.

$${D}_{i}^{f} = μ {D}_{i} + ( 1 - μ ) {D}_{i}^{′} \qquad ( 5 )$$

In equation (5), Dᵢ^{f}, Dᵢ, and Dᵢ′ represent an ith fusion code, an ith depth code, and an ith reverse depth code, respectively; μ and 1−μ are weights of Dᵢ and Dᵢ′, respectively; and μ∈(0,1), a specific value of which can be set by a worker, for example, set to μ=0.6.

In another specific embodiment, the fusion processing manner can be direct summing or averaging.

3) Based on the n fusion codes obtained above, the denoising processing is improved: In any ith Unet model, after second fusion processing is performed on an output of a downsampling module of the ith Unet model and an ith fusion code, it is inputted to a next module. For example, the second fusion processing can include summing, averaging, weighted summing, etc.

As such, a continuity problem of a video frame is further decomposed into a consistency maintenance sub-problem of the far and near fields, and a generated video frame is constrained to maintain consistency of details of far and near fields by performing a negation operation.

In another improvement manner, in consideration of a longer calculation time consumed for serial processing of n pieces of depth information (or n pieces of reverse depth information) by using a single depth information coding model, it is proposed that n depth information encoders obtained by copying the depth information encoder process the n pieces of depth information (or the n pieces of reverse depth information) in parallel to obtain n depth codes (or n reverse depth codes).

The previous describes improvement on using depth information to guide denoising processing. It should be understood that, in addition to using depth information to guide denoising processing, another category of image information, such as edge information or an optical flow graph, can be used. A process of using another category of image information to guide denoising processing is similar to a process of using depth information to guide denoising processing. References can be made for performing, but no negation operation is performed. For example, assume that another category of image information is edge information, the depth information, the depth information encoder, and the depth code in the above-mentioned some embodiments can be logically and correspondingly replaced with edge information, an edge information encoder, and an edge information code.

The previous describes an execution process of step S330, including performing denoising processing on the n noised codes by using the text code and the n Unet models. In addition, it is mentioned in the previous that noise addition processing recorded in step S310 can be further improved. Specifically, noise addition can be performed by using the Unet model. A noise addition process is similar to a denoising process performed by using the Unet model. A difference lies in that content inputted to the Unet model during noise addition and denoising is different, and therefore outputted content is also different.

To distinguish the description, the n Unet models used for denoising processing are denoted as n first Unet models, and the n Unet models used for noise addition processing are denoted as n second Unet models. It can be understood that the n second Unet models are also obtained by copying the Unet model in the text-to-image model. It is worthwhile to note that “first” in the first Unet model, “second” in the second Unet model, and a similar term elsewhere in this specification are all intended to distinguish the same type of things, and do not have another limitation function such as sorting.

It can be learned from the description of the above-mentioned embodiments that the denoising processing includes using a text code of a description text and an ith noised code as inputs to an ith first Unet model. In addition to outputs of above-mentioned target network layers adjacent thereto, inputs to some or all self-attention layers in the n first Unet models further include an output of a target network layer in a target first Unet model, so as to implement cross-frame interaction. Further, it is proposed that a denoising process can further be guided by using a fusion code corresponding to depth information and reverse depth information obtained by performing a negation operation.

Correspondingly, the noise addition processing can include using a text code set to zero (that is, a text code of which all elements are 0) and an ith original code corresponding to an ith video frame as inputs to an ith second Unet model. In addition to outputs of above-mentioned target network layers adjacent thereto, inputs to some or all self-attention layers in the n second Unet models further include an output of a target network layer in a target second Unet model, so as to implement cross-frame interaction. As such, cross-frame interaction is implemented in a noise addition process, so optimization of a noised code can be implemented, and coherence of an edited video is further improved. In addition, the noise addition process can further be guided by using a fusion code corresponding to depth information and reverse depth information obtained by performing a negation operation. As such, a subsequently generated target image can be further constrained to maintain consistency of details of far and near fields.

The previous describes the improvement on the noise addition processing in step S310. Back to step S330, the n denoised codes corresponding to the n original video frames can be obtained through execution.

Based on the n denoised codes, step S340 is performed: separately process the n denoised codes by using an image decoder to obtain n target images, so as to form an edited target video.

According to an embodiment of another aspect, after step S340, the video editing method can further include step S350 (step S350 is not shown in FIG. 3): determine the edited target video based on the n target images.

In an implementation, to better maintain coherence between generated video frames, an area requiring no editing in the original video is shaded in the video editing method, so a generation process only works in an editing area. In this case, an outputted target video needs to be obtained in a replacement or fusion manner in this step.

Specifically, the coding processing in step S310 includes: generating, for each original video frame in the original video, a binary image used to shade an area requiring no editing; and then processing, by using the image encoder, a complete pixel image of the video frame and a shaded pixel image obtained by performing element-wise multiplication on the binary image, to obtain a corresponding original code.

It should be understood that an element in the binary image is one of two different values. For example, a matrix element corresponding to an area requiring no editing in the binary image is 0, and a matrix element corresponding to another area (or referred to as a target area requiring editing) is 1.

It can be understood that after the target area requiring editing is determined, a non-target area requiring no editing is determined accordingly. There are multiple manners of determining the target area. In an embodiment, a target area inputted by a user based on a video editing interface can be received. In a specific embodiment, a target area delineated by the user in an original video frame by using a brush tool can be received, and then a target area of another original video frame is dynamically tracked by using a machine learning algorithm, so a target area requiring editing in each original video frame can be obtained. In another specific embodiment, each object detected by using a target detection algorithm can be first displayed on the video editing interface to the user, so the user clicks to select some objects, and image areas in which the some objects are located are used as target areas. In another embodiment, a target area requiring editing can alternatively be automatically obtained by matching the description text guiding video editing against the video frame. For example, a trained classification model can be used to process the description text, so as to obtain an object category that is indicated by the description text and that is intended to be edited by the user, and then the object category is matched against a category of each object detected from the original video by using the target detection algorithm, so as to locate the target area.

Based on this, this step includes: for each target image in the n target images, fusing the target image with an image of an area requiring no editing in a corresponding original video frame, to obtain a corresponding target video frame, so as to construct the edited target video by using n target video frames corresponding to the n target images.

In another implementation, in step S310, a complete pixel image of each original video frame is directly coded. In this case, a generated target image is complete, and the target video can be directly constructed by using the n target images.

As such, an edited video with good coherence can be obtained. It is worthwhile to note that the video editing method disclosed in this embodiment of this specification is particularly applicable to a short video having an original video of 3-5 s and including a moving object. In addition, the above-mentioned embodiments mainly describe improved technical content. For a technical point that is not described, implementation can be performed still in an existing manner. For example, performing noise addition processing by using n Unet models includes T loop iterations. Correspondingly, performing denoising processing by using n Unet models also includes T loop iterations. For another example, in each loop iteration involved in noise addition processing or denoising processing, an input to the Unet model further includes a current loop iteration round t, etc.

In conclusion, according to the video editing method disclosed in this embodiment of this specification, no additional training needs to be performed on the pre-trained text-to-image model, but the text-to-image model can be directly used to process the original video and the description text guiding video editing, so as to generate an edited video with a good visual effect and better consistency.

In the video editing method shown in FIG. 3, the n Unet models obtained by copying the Unet model are used to perform denoising processing on the n denoised codes. In fact, instead of copying the Unet model, batch processing of the n video frames can alternatively be implemented by using a batch channel used when the model processes multiple samples in a batch. It can be understood that a processing result is the same as a result obtained by performing denoising processing by using the n Unet models in the above-mentioned embodiment.

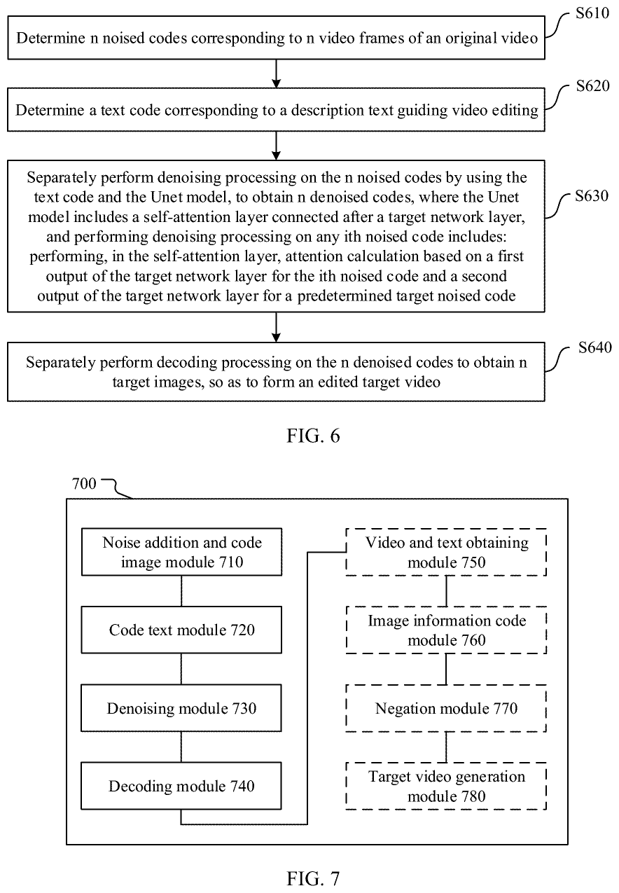

FIG. 6 is a second schematic flowchart of a process step of a video editing method disclosed in an embodiment of this specification. The video editing method is implemented based on a pre-trained text-to-image model. The video editing method can be performed by any apparatus, server, platform, or device cluster having computing and processing capabilities, for example, can be video editing software.

As shown in FIG. 6, the method includes the following steps:

Step S610: Determine n noised codes corresponding to n video frames of an original video.

Specifically, first coding processing is performed on the n video frames to obtain n original codes, and then noise addition processing is separately performed on the n original codes, to obtain the n noised codes. In an embodiment, the noise addition processing includes: separately performing noise addition processing on the n original codes by using a text code set to zero and a Unet model, to obtain the n noised codes.

In addition, it is worthwhile to note that, for descriptions of step S610, references can be made to related descriptions of step S310.

Step S620: Determine a text code corresponding to a description text guiding video editing.

It is worthwhile to note that, for descriptions of step S620, references can be made to descriptions of step S320. Details are omitted.

Step S630: Separately perform denoising processing on the n noised codes by using the text code and the Unet model, to obtain n denoised codes, where the Unet model includes a self-attention layer connected after a target network layer, and performing denoising processing on any ith noised code includes: performing, in the self-attention layer, attention calculation based on a first output of the target network layer for the ith noised code and a second output of the target network layer for a predetermined target noised code.

The target noised code can be flexibly specified. In an embodiment, a target noised code corresponding to each noised code is the same, for example, is a predetermined jth noised code (for example, j=1). In another embodiment, a target noised code corresponding to an ith noised code is an (i−1)th noised code, and a target noised code of the first noised code is itself or another noised code, for example, the second noised code.

In an embodiment, the attention calculation includes: processing the first output in the self-attention layer by using a query parameter matrix, to obtain a query matrix Q; separately processing the second output by using a key parameter matrix and a value parameter matrix, to obtain a key matrix K and a value matrix V; and determining an output of a current self-attention layer based on the query matrix Q, the key matrix K, and the value matrix V. In another embodiment, the attention calculation can be implemented with reference to the above-mentioned equation (3).

In addition, in an embodiment, the text-to-image model further includes an image information encoder for image information of a predetermined category, and a self-attention layer of the Unet model is located in a downsampling module; and before the separately performing denoising processing on the n noised codes by using the text code and the Unet model, the method further includes: extracting n pieces of image information in the image information of the predetermined category from the n video frames; and separately processing the n pieces of image information by using the image information encoder, to obtain n information codes. The denoising processing further includes: in the Unet model, fusing an output of a downsampling module of the Unet model for an ith noised code with an ith information code, and inputting to a next module.

In addition, it is worthwhile to note that, for descriptions of step S630, references can be made to related descriptions of step S630.

Step S640: Separately perform decoding processing on the n denoised codes to obtain n target images, so as to form an edited target video.

It is worthwhile to note that, for descriptions of step S640, references can be made to descriptions of step S340. Details are omitted.

In conclusion, according to the video editing method disclosed in this embodiment of this specification, no additional training needs to be performed on the pre-trained text-to-image model, but the text-to-image model can be directly used to process the original video and the description text guiding video editing, so as to generate an edited video with a good visual effect and better consistency.

Corresponding to the above-mentioned video editing method, an embodiment of this specification further discloses a video editing apparatus. FIG. 7 is a first schematic structural diagram of a video editing apparatus disclosed in an embodiment of this specification. A function of the apparatus is implemented based on a pre-trained text-to-image model, where the text-to-image model includes a Unet model. As shown in FIG. 7, the video editing apparatus 700 includes: a noise addition and code image module 710, configured to determine n noised codes corresponding to n video frames of an original video; a code text module 720, configured to determine a text code corresponding to a description text guiding video editing; a denoising module 730, configured to perform denoising processing on the n noised codes by using the text code and n Unet models obtained by copying the Unet model, to obtain n denoised codes, where each Unet model includes a self-attention layer connected after a target network layer, and the denoising processing includes: performing, in a self-attention layer of any ith Unet model, attention calculation based on an output of a target network layer of the ith Unet model and an output of a target network layer in a predetermined target Unet model; and a decoding module 740, configured to separately perform decoding processing on the n denoised codes to obtain n target images, so as to form an edited target video.

In an embodiment, the pre-trained training data include a text-image pair.

In an embodiment, the video editing apparatus 700 further includes a video and text acquisition module 750, configured to obtain the original video and the description text that are inputted by a user.

In an embodiment, the denoising module 730 is specifically configured to: process, by using a query parameter matrix in the self-attention layer of the any ith Unet model, the output of the target network layer of the ith Unet model, to obtain a query matrix Q; process the output of the target network layer in the target Unet model by separately using a key parameter matrix and a value parameter matrix, to obtain a key matrix K and a value matrix V; and determine an output of a current self-attention layer based on the query matrix Q, the key matrix K, and the value matrix V.

In an embodiment, the text-to-image model further includes an image information encoder for image information of a predetermined category, and a self-attention layer of the any Unet model is located in a downsampling module. The video editing apparatus 700 further includes an image information code module 760, configured to: extract n pieces of image information in the image information of the predetermined category from the n video frames; and separately process the n pieces of image information by using the image information encoder, to obtain n information codes. The denoising module 730 is specifically configured to: in any ith Unet model, fuse an output of a downsampling module of the ith Unet model with an ith information code, and input to a next module.

In a specific embodiment, the image information code module 760 is specifically configured to: process the n pieces of image information in parallel by using n image information encoders obtained by copying the image information encoder, to obtain the n image information codes.

In one aspect, in another specific embodiment, the predetermined image information category includes depth information, edge information, or an optical flow graph of an image.

In another aspect, in a specific embodiment, the predetermined image information category includes depth information, the image information encoder is a depth information encoder, the n pieces of image information are n pieces of depth information, and the n information codes are n depth codes. The video editing apparatus 700 further includes a negation module 770, configured to: separately perform a negation operation on the n pieces of depth information to obtain n pieces of reverse depth information; separately process the n pieces of reverse depth information by using the depth information encoder, to obtain n reverse depth codes; and update each depth code of the n depth codes to a fusion result between the depth code and a corresponding reverse depth code.

Further, in an example, the negation module 770 is further configured to: perform weighted summation on each depth code and the corresponding reverse depth code by using a predetermined weight, to obtain a corresponding fusion result.

In an embodiment, the text-to-image model further includes an image encoder. The noise addition and code image module 710 is specifically configured to: separately perform coding processing on the n video frames by using the image encoder, to obtain n original codes; and perform noise addition processing on the n original codes to obtain the n noised codes.

In a specific embodiment, the noise addition and code image module 710 is further configured to: generate, for each video frame in the n video frames, a binary image used to shade an area requiring no editing; and process, by using the image encoder, a complete pixel image of the video frame and a shaded pixel image obtained by performing element-wise multiplication on the binary image, to obtain a corresponding original code. The video editing apparatus 700 further includes a target video generation module 780, configured to: for each target image in the n target images, fuse the target image with an image of an area requiring no editing in a corresponding video frame, to obtain a corresponding target video frame; and construct the target video by using n target video frames corresponding to the n target images.

According to another aspect, in a specific embodiment, the n Unet models are n first Unet models. The noise addition and code image module 710 is further configured to: perform noise addition processing on the n original codes by using a text code set to zero and n second Unet models obtained by copying the Unet model, to obtain the n noised codes.

In an embodiment, the text-to-image model further includes an image decoder. The decoding module 740 is specifically configured to separately process the n denoised codes by using the image decoder, to obtain the n target images.

In an embodiment, the Unet model includes multiple downsampling modules, several intermediate modules, and multiple upsampling modules, where each of the modules includes the self-attention layer.

In a specific embodiment, each of the modules further includes a convolutional layer, an activation layer, a pooling layer, a cross-attention layer, and a fully connected layer, and an input to the cross-attention layer includes a text code.

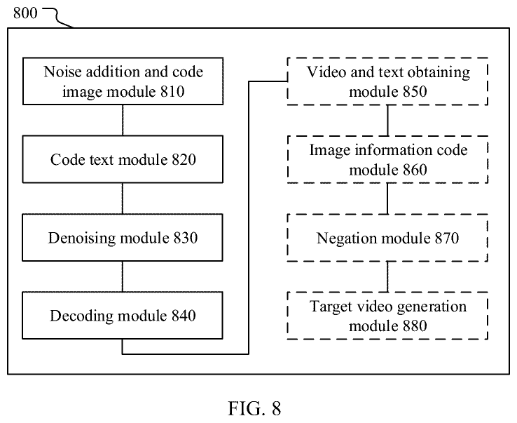

FIG. 8 is a second schematic structural diagram of a video editing apparatus disclosed in an embodiment of this specification. A function of the apparatus is implemented based on a pre-trained text-to-image model, where the text-to-image model includes a Unet model. As shown in FIG. 8, the video editing apparatus 800 includes: a noise addition and code image module 810, configured to determine n noised codes corresponding to n video frames of an original video; a code text module 820, configured to determine a text code corresponding to a description text guiding video editing; a denoising module 830, configured to: separately perform denoising processing on the n noised codes by using the text code and the Unet model, to obtain n denoised codes, where the Unet model includes a self-attention layer connected after a target network layer, and performing denoising processing on any ith noised code includes: performing, in the self-attention layer of the Unet model, attention calculation based on a first output of the target network layer for the ith noised code and a second output of the target network layer for a predetermined target noised code; and a decoding module 840, configured to separately perform decoding processing on the n denoised codes to obtain n target images, so as to form an edited target video.

In an embodiment, the pre-trained training data include a text-image pair.

In an embodiment, the video editing apparatus 800 further includes a video and text acquisition module 850, configured to obtain the original video and the description text that are inputted by a user.

In an embodiment, the denoising module 830 is specifically configured to: process the first output in the self-attention layer by using a query parameter matrix, to obtain a query matrix Q; separately process the second output by using a key parameter matrix and a value parameter matrix, to obtain a key matrix K and a value matrix V; and determine an output of a current self-attention layer based on the query matrix Q, the key matrix K, and the value matrix V.

In an embodiment, the text-to-image model further includes an image information encoder for image information of a predetermined category, and a self-attention layer of the Unet model is located in a downsampling module. The video editing apparatus 800 further includes an image information code module 860, configured to: extract n pieces of image information in the image information of the predetermined category from the n video frames; and separately process the n pieces of image information by using the image information encoder, to obtain n information codes. The denoising module 830 is specifically configured to: in the Unet model, fuse an output of a downsampling module of the Unet model for an ith noised code with an ith information code, and input to a next module.

In a specific embodiment, the image information code module 860 is specifically configured to: process the n pieces of image information in parallel by using n image information encoders obtained by copying the image information encoder, to obtain the n image information codes.

In one aspect, in another specific embodiment, the predetermined image information category includes depth information, edge information, or an optical flow graph of an image.

In another aspect, in a specific embodiment, the predetermined image information category includes depth information, the image information encoder is a depth information encoder, the n pieces of image information are n pieces of depth information, and the n information codes are n depth codes. The video editing apparatus 800 further includes a negation module 870, configured to: separately perform a negation operation on the n pieces of depth information to obtain n pieces of reverse depth information; separately process the n pieces of reverse depth information by using the depth information encoder, to obtain n reverse depth codes; and update each depth code of the n depth codes to a fusion result between the depth code and a corresponding reverse depth code.

Further, in an example, the negation module 870 is further configured to: perform weighted summation on each depth code and the corresponding reverse depth code by using a predetermined weight, to obtain a corresponding fusion result.

In an embodiment, the text-to-image model further includes an image encoder. The noise addition and code image module 810 is specifically configured to: separately perform coding processing on the n video frames by using the image encoder, to obtain n original codes; and perform noise addition processing on the n original codes to obtain the n noised codes.

In a specific embodiment, the noise addition and code image module 810 is further configured to: generate, for each video frame in the n video frames, a binary image used to shade an area requiring no editing; and process, by using the image encoder, a complete pixel image of the video frame and a shaded pixel image obtained by performing element-wise multiplication on the binary image, to obtain a corresponding original code. The video editing apparatus 800 further includes a target video generation module 880, configured to: for each target image in the n target images, fuse the target image with an image of an area requiring no editing in a corresponding video frame, to obtain a corresponding target video frame; and construct the target video by using n target video frames corresponding to the n target images.

In another aspect, in a specific embodiment, the noise addition and code image module 810 is further configured to: separately perform noise addition processing on the n original codes by using a text code set to zero and the Unet model, to obtain the n noised codes.

In an embodiment, the text-to-image model further includes an image decoder. The decoding module 840 is specifically configured to separately process the n denoised codes by using the image decoder, to obtain the n target images.

In an embodiment, the Unet model includes multiple downsampling modules, several intermediate modules, and multiple upsampling modules, where each of the modules includes the self-attention layer.

In a specific embodiment, each of the modules further includes a convolutional layer, an activation layer, a pooling layer, a cross-attention layer, and a fully connected layer, and an input to the cross-attention layer includes a text code.

According to an embodiment of another aspect, a computer-readable storage medium is further provided, on which a computer program is stored. When the computer program is executed in a computer, the computer is caused to perform the method described with reference to FIG. 3 or FIG. 6.

According to some embodiments of still another aspect, a computing device is further provided, including a memory and a processor. Executable code is stored in the memory, and when the processor executes the executable code, the method described with reference to FIG. 3 or FIG. 6 is implemented. A person skilled in the art should be aware that in the above-mentioned one or more examples, functions described in the present disclosure can be implemented by hardware, software, firmware, or any combination thereof. When the functions are implemented by software, the functions can be stored in a computer-readable medium or transmitted as one or more instructions or code on the computer-readable medium.

Specific implementations described above further describe the purposes, technical solutions, and beneficial effects of this application. It should be understood that the above-mentioned descriptions are merely some specific implementations of this application and are not intended to limit the protection scope of this application. Any modification, equivalent replacement, or improvement made based on the technical solutions of this application shall fall within the protection scope of this application.

What is claimed is:

1. A computer-implemented method for video editing, comprising:
determining n noised codes corresponding to n video frames of an original video;
determining a text code corresponding to a description text guiding video editing;
performing, using n Unet models obtained by using the text code and copying a Unet model denoising processing on the n noised codes, to obtain n denoised codes, wherein a pre-trained text-to-image model comprises the Unet model, wherein each Unet model comprises a self-attention layer connected after a target network layer, and wherein the denoising processing comprises:
performing, in a self-attention layer of any ith Unet model, attention calculation based on an output of a target network layer of the ith Unet model and an output of a target network layer in a predetermined target Unet model; and
separately performing, using an image decoder, decoding processing on the n denoised codes to obtain n target images, so as to form an edited target video.

2. The computer-implemented method of claim 1, wherein pre-trained training data comprises a text-image pair.

3. The computer-implemented method of claim 1, wherein, before determining n noised codes corresponding to n video frames of an original video, and before determining a text code corresponding to a description text guiding video editing:
obtaining the original video and the description text that are inputted by a user.

4. The computer-implemented method of claim 1, wherein performing, in a self-attention layer of any ith Unet model, attention calculation based on an output of a target network layer of the ith Unet model and an output of a target network layer in a predetermined target Unet model, comprises:
processing, by using a query parameter matrix in the self-attention layer of any ith Unet model, the output of the target network layer of the ith Unet model, to obtain a query matrix Q;
processing the output of the target network layer in the predetermined target Unet model by separately using a key parameter matrix and a value parameter matrix, to obtain a key matrix K and a value matrix V; and
determining an output of a current self-attention layer based on the query matrix Q, the key matrix K, and the value matrix V.

5. The computer-implemented method of claim 1, wherein:
the pre-trained text-to-image model comprises an image information encoder for image information of a predetermined category and a self-attention layer of the any ith Unet model is located in a downsampling module; and
before performing denoising processing on the n noised codes by using n Unet models obtained by using the text code and copying the Unet model, to obtain n denoised codes:
extracting n pieces of image information in the image information of the predetermined category from n video frames of an original video; and
separately processing, by using the image information encoder, the n pieces of image information to obtain n image information codes; and
the denoising processing comprises:
in any ith Unet model, fusing an output of a downsampling module of the ith Unet model with an ith information code, and inputting to a next module.

6. The computer-implemented method of claim 5, wherein separately processing, by using the image information encoder, the n pieces of image information to obtain n image information codes, comprises:
processing, using n image information encoders obtained by copying the image information encoder and in parallel, the n pieces of image information to obtain the n image information codes.

7. The computer-implemented method of claim 5, wherein the image information of the predetermined category comprises depth information, edge information, or an optical flow graph of an image.

8. The computer-implemented method of claim 5, wherein:
the image information of the predetermined category comprises depth information, the image information encoder is a depth information encoder, the n pieces of image information are n pieces of depth information, and the n image information codes are n depth codes; and
before performing denoising processing:
separately performing a negation operation on the n pieces of depth information to obtain n pieces of reverse depth information;
separately processing the n pieces of reverse depth information by using the depth information encoder, to obtain n reverse depth codes; and
updating each depth code of the n depth codes to a fusion result between the depth code and a corresponding reverse depth code.

9. The computer-implemented method of claim 8, wherein updating each depth code of the n depth codes to a fusion result between the depth code and a corresponding reverse depth code, comprises:
performing weighted summation on each depth code and the corresponding reverse depth code by using a predetermined weight, to obtain a corresponding fusion result.

10. The computer-implemented method of claim 1, wherein:
the pre-trained text-to-image model comprises an image encoder; and
determining n noised codes corresponding to n video frames of an original video, comprises:
separately performing, using the image encoder, coding processing on n video frames of an original video to obtain n original codes; and
performing noise addition processing on the n original codes to obtain the n noised codes.

11. The computer-implemented method of claim 10, wherein separately performing, using the image encoder, coding processing on the n video frames of an original video to obtain n original codes, comprises:
generating, for each video frame in the n video frames of an original video, a binary image used to shade an area requiring no editing; and processing, by using the image encoder, a complete pixel image of the video frame and a shaded pixel image obtained by performing element-wise multiplication on the binary image, to obtain a corresponding original code.

12. The computer-implemented method of claim 11, wherein, after separately processing, using the image decoder, the n denoised codes to obtain n target images:
for each target image in the n target images, fusing the target image with an image of an area requiring no editing in a corresponding video frame, to obtain a corresponding target video frame; and
constructing the edited target video by using n target video frames corresponding to the n target images.

13. The computer-implemented method of claim 10, wherein the n Unet models are n first Unet models.

14. The computer-implemented method of claim 10, wherein performing noise addition processing on the n original codes to obtain the n noised codes, comprises:
performing, by using n second Unet models obtained by using a text code set to zero and copying the Unet model, noise addition processing on the n original codes to obtain the n noised codes.

15. The computer-implemented method of claim 1, wherein the pre-trained text-to-image model comprises an image decoder.

16. The computer-implemented method of claim 15, wherein separately performing decoding processing on the n denoised codes to obtain n target images, comprises:
separately processing the n denoised codes by using the image decoder, to obtain the n target images.

17. The computer-implemented method of any one of claim 1, wherein the Unet model comprises multiple downsampling modules, several intermediate modules, and multiple upsampling modules, and wherein each of the modules comprises the self-attention layer.

18. The computer-implemented method of claim 17, wherein each of the modules comprises a convolutional layer, an activation layer, a pooling layer, a cross-attention layer, and a fully connected layer, and wherein an input to the cross-attention layer comprises a text code.

19. A non-transitory, computer-readable medium storing one or more instructions executable by a computer system to perform one or more operations for video editing, comprising:
determining n noised codes corresponding to n video frames of an original video;
determining a text code corresponding to a description text guiding video editing;
performing, using n Unet models obtained by using the text code and copying a Unet model denoising processing on the n noised codes, to obtain n denoised codes, wherein a pre-trained text-to-image model comprises the Unet model, wherein each Unet model comprises a self-attention layer connected after a target network layer, and wherein the denoising processing comprises:
performing, in a self-attention layer of any ith Unet model, attention calculation based on an output of a target network layer of the ith Unet model and an output of a target network layer in a predetermined target Unet model; and
separately performing, using an image decoder, decoding processing on the n denoised codes to obtain n target images, so as to form an edited target video.

20. A computer-implemented system for video editing, comprising:
one or more computers; and
one or more computer memory devices interoperably coupled with the one or more computers and having tangible, non-transitory, machine-readable media storing one or more instructions that, when executed by the one or more computers, perform one or more operations, comprising:
determining n noised codes corresponding to n video frames of an original video;
determining a text code corresponding to a description text guiding video editing;
performing, using n Unet models obtained by using the text code and copying a Unet model denoising processing on the n noised codes, to obtain n denoised codes, wherein a pre-trained text-to-image model comprises the Unet model, wherein each Unet model comprises a self-attention layer connected after a target network layer, and wherein the denoising processing comprises:
performing, in a self-attention layer of any ith Unet model, attention calculation based on an output of a target network layer of the ith Unet model and an output of a target network layer in a predetermined target Unet model; and
separately performing, using an image decoder, decoding processing on the n denoised codes to obtain n target images, so as to form an edited target video.
